(19) United States
(12) Patent Application Publication
(10) Pub. No.: US 2007/0143230 A1
(43) Pub. Date: Jun. 21, 2007

(54) Transaction verification system

(75) Inventors: Selvanathan Narainsamy, Kwazulu-Natal (ZA); Adele Katrine Narainsamy, Kwazulu-Natal (ZA); Andrew Gary Wright, Kwazulu-Natal (ZA)

Correspondence Address: BIRCH STEWART KOLASCH & BIRCH, PO BOX 747, FALLS CHURCH, VA, 22040-0747, US

(73) Assignee: Selvanathan Narainsamy, Durban, Kwazulu-Natal (ZA)

(21) Appl. No.: 10/562,672

(22) PCT Filed: Jun. 30, 2004
(86) PCT No.: PCT/ZA04/00072

§ 371 Date: Jun. 12, 2006

(30) Foreign Application Priority Data
Jun. 30, 2003 (ZA) 2003/5129
Sep. 8, 2003 (ZA) 2003/6980
Nov. 6, 2003 (ZA) 2003/8654

(51) Int. Cl. G06Q 99/00

(52) U.S. Cl. 705/75

(57) ABSTRACT

This invention uses separate, parallel communication channels to authorise and authenticate a transaction. A primary data channel (PSTN, radio or the like) is used to communicate between the merchant terminal and the bank, and a parallel data channel (a mobile phone network for instance) is used for the authentication process. In the example, the transaction is initiated (on a primary data channel), using a POS terminal as a transaction processing client. The transaction processing server and financial services provider fulfill their normal functions. At this point, the process loops into a transaction authorisation component using the parallel data channel, that requires authentication of the transaction initiator (the card holder). In the example, communications on the parallel data channel are by way of SMS. In the authorisation process, the card holder receives an SMS requesting authorisation of the transaction. If the card holder is not the transaction initiator, the card holder can cancel the transaction. If the transaction can be authorised, an authentication process is initiated in which the mobile phone is programmed to require the entry of a normally secret code (such as a personal identification number (PIN)) that serves to authenticate the card holder and to give final authorisation of the transaction.

### BACKGROUND TO THE INVENTION

This invention relates to a system for processing financial transactions.

In the current systems employed for the authorisation of financial transactions, it is difficult and often impossible to obtain a firm guarantee that the person initiating the transaction is authentic and authorised to conclude the transaction. Currently the processes employed by financial institutions do little more than guarantee the availability of funds in the account in issue. It is a process that provides no more than authorisation of the transaction after ensuring that funds are available to complete the transaction. Unfortunately, however, the process does not provide any form of authentication or any other indication that the individual making the transaction is indeed the authentic and authorised to operate the particular account.

This lack of authentication is a problem and gives rise to a number of fraud situations, particularly in internet-based transactions.

The invention also finds application in avoiding fraud in cheque-based transactions. Notwithstanding the increase in electronic funds transfer mechanisms and the increased use of such mechanisms, cheques remain one of the dominant methods of payment in commerce, particularly where larger amounts are concerned. Unfortunately, cheques are a relatively easy target for fraud. This is due largely to the fact that cheque fraud detection remains a predominately manual operation.

This invention seeks to address the above mentioned problems by providing an authentication mechanism and process that takes place before the transaction is authorised.

In addition, the invention seeks to introduce a mechanism at least partly to automate these processes rather than relying on current manual verification and authentication processes.

In essence, this invention is characterised by the use of two separate (parallel) communication channels to authorise a transaction. Practically, this implies that a primary data channel (Public subscriber Telephone Network (PSTN), radio or the like) is used to communicate between the merchant terminal and the bank, and a different data channel (a mobile phone network for instance) is used for the authentication process between bank and client. The advantage of this methodology is that if any fraud is perpetrated, the data on both communication channels would need to be intercepted and synchronised. With a 128-bit encryption key and less than two minutes (in current practice in South Africa) before the request from the bank server times out, hacking into this system is improbable.

This document outlines the use of such a parallel authorisation and authentication system using the PSTN as the primary data channel and a mobile phone (GSM) network as the channel running in parallel for authentication.

In the context of this specification:
a “server” is any entity, machine, system or application that provides the functionality required by the financial transaction verification system of this invention;
an “authorisation code” is a code or other data, normally kept secret, that is required to allow a transaction to be concluded;
“control” is the ability to authorise or prohibit the processing of a transaction, normally by providing or withholding an authorisation code or other data required to allow the transaction to be concluded;
the terms “telecommunication” and “telecommunications” are used largely in the conventional sense of referring to communications on a telephone network, but the terms are not necessarily intended to be limited to such an interpretation in every instance and where a wider interpretation is possible in the context, then the terms should be interpreted widely, such as to include two-way radio communications for instance;
whilst the specification outlines the use of a parallel authorisation and authentication system using the PSTN as the primary data channel and a mobile phone (GSM) network as the channel running in parallel for authentication, it will be appreciated that this is done purely for the purposes of illustration and is not intended to limit the scope of the invention to such communication channels.

### SUMMARY OF THE INVENTION

The financial transaction verification system of this invention comprises:
a transaction processing client;
a transaction processing server under the control of a financial services provider
a programmable telecommunications client under the control of a transaction initiator;
the transaction processing client, the transaction processing server and the telecommunications client all being connected to or adapted for connection to a telecommunications network;
the transaction processing client being adapted, when in use a transaction is initiated and processed through the transaction processing client, to record:
   data pertaining to a transaction initiated, in use, by the transaction initiator; and
   data pertaining to a financial account of the transaction initiator with the financial services provider;
the transaction processing client being adapted to transmit the recorded data to the transaction processing server by way of the telecommunications network;
the transaction processing server being adapted to make use of data pertaining to the transaction initiator and the telecommunications client previously stored with the financial services provider to formulate a transaction authorisation request to the telecommunications client;
the transaction processing server being adapted to transmit the transaction authorisation request to the telecommunications client by way of the telecommunications network;
the telecommunications client being programmed to require the entry of an authorisation code into the telecommunications client as a precondition for the further processing of the transaction authorisation request; and
the telecommunications client being programmed, further, to transmit a process outcome message to either or both the transaction processing server and the transaction processing client, which process outcome message:
   if the incorrect authorisation code is entered, is constituted by a transaction cancellation signal; and
   if the correct authorisation code is entered, is constituted by a transaction authorisation signal.

The financial transaction verification system may conveniently use a mobile communication device (such as a mobile phone) that is personal to the transaction initiator as the telecommunications client, in which case:
the transaction initiator data previously stored with the financial services provider includes unique mobile communication device data, which is data that is unique to and stored in the mobile communication device;
the transaction processing server is adapted to transmit the previously stored unique mobile communication device data to the mobile communication device together with the authorisation request;
the mobile communication device is programmed, on receipt of the transmitted data, to compare the transmitted data to the equivalent unique mobile communication device data stored in the mobile communication device;
the telecommunications client is programmed, further, to transmit a process outcome message to either or both the transaction processing server and the transaction processing client, which process outcome message may, alternatively, be constituted by a transaction cancellation signal or a transaction authorisation signal;
the mobile communication device being programmed, further:
   if the comparison between the transmitted data and the equivalent data stored in the mobile communication device fails, to transmit a process outcome message constituted by a transaction cancellation signal; and
   if the comparison is successful, to require the entry, into the mobile communication device, of the authorisation code previously provided as a precondition for the further processing of the transaction authorisation request; and
   if the incorrect authorisation code is entered, to transmit a process outcome message constituted by a transaction cancellation signal; and
   if the correct authorisation code is entered to transmit a process outcome message constituted by a transaction authorisation signal.

The system may be adapted to cancel the transaction in the event of the receipt, by the telecommunications client, of a transaction cancellation signal and to allow the transaction to proceed to finality in the event of the receipt, by the telecommunications client, of a transaction authorisation signal.

The invention includes one or more of:
a transaction processing client;
a transaction processing server;
a telecommunications server; and
a telecommunications client

for use with a system such as that described above.

In addition, the invention includes a method of verifying a financial transaction comprising the steps of:
initiating a transaction at a transaction processing client;

recording, by means of the transaction processing client, data pertaining to the transaction together with data pertaining to a financial account of the transaction initiator with a financial services provider;
transmitting the data so recorded from the transaction processing client to a transaction processing server under control of the financial services provider, by way of a telecommunications network,
supplying, to the transaction processing server, data previously stored with the financial services provider and pertaining to a telecommunications client which is under the control of the transaction initiator;
transmitting an authorisation request pertaining to the initiated transaction to the telecommunications client;
requiring, on receipt of such a transaction authorisation request, the entry into the telecommunications client, of an authorisation code as a precondition for the further processing of the transaction authorisation request;
transmitting a process outcome message to either or both the transaction processing server and the transaction processing client, which process outcome message:
   if the incorrect authorisation code is entered, is constituted by a transaction cancellation signal; and
   if the correct authorisation code is entered, is constituted by a transaction authorisation signal.

In the event that the telecommunications client is a mobile communication device personal to the transaction initiator (such as a mobile phone), the method described above may include the preliminary step of storing data unique to and stored in the mobile communication device at the financial services provider as part of the communications data pertaining to the transaction initiator, the method including the additional steps of:
transmitting the unique mobile communication device data from the transaction processing server to the mobile communication device together with the authorisation request;
in the mobile communication device, comparing, on receipt of the transmitted data and authorisation request, the transmitted unique mobile communication device data to the equivalent mobile communication device data stored in the mobile communication device; and
   if the comparison between the transmitted data and the equivalent data stored in the mobile communication device fails, transmitting a transaction cancellation signal to either or both the transaction processing server and the transaction processing client; and
   if the comparison is successful, requiring the entry of the authorisation code previously provided into the mobile communication device as a precondition for the further processing of the transaction authorisation request; and
   if the incorrect authorisation code is entered, transmitting a transaction cancellation signal to either or both the transaction processing server and the transaction processing client; and
   if the correct code is entered, transmitting a transaction authorisation signal to either or both the transaction processing server and the transaction processing client.

A method of verifying a financial transaction may conveniently include the additional steps of:
canceling the transaction in the event of the receipt, by the telecommunications client, of a transaction cancellation signal; and
allowing the transaction to proceed to finality in the event of the receipt, by the telecommunications client, of a transaction authorisation signal.

The method of verifying a financial transaction finds additional application in verifying transactions involving the use of a documentary negotiable instrument, in which event the method may conveniently comprise the steps of:
initiating the transaction by a participating negotiable instrument issuer issuing the negotiable instrument manually;
recording, by means of the transaction processing client, data pertaining to the transaction including predetermined data pertaining to the negotiable instrument;
transmitting the data so recorded from the transaction processing client to the transaction processing server by way of the telecommunications network,
transmitting, to either or both the financial services provider and the transaction processing server, a negotiable instrument issuer code unique to the negotiable instrument issuer, thereby to confirm, to the transaction processing server, the transmitted data pertaining to the transaction including the predetermined data pertaining to the negotiable instrument;
recording, at the transaction processing server, the data so confirmed; and
comparing, when in use the negotiable instrument is presented for payment, the data on the face of the documentary negotiable instrument with the data recorded in the transaction processing server in respect of that negotiable instrument.

In this way the negotiable instrument issuer by using a unique negotiable instrument issuer code, in essence places an “electronic signature” on the negotiable instrument. If the data on the face of the negotiable instrument is modified, the negotiable instrument will fail the comparison step outlined above when the negotiable instrument is presented for payment, in which event payment can be refused.

The invention extends to the verification of financial transactions involving the use of a communications enabled transaction terminal as the transaction processing client, the method including the steps of:
with the use of the mobile communication device, formulating and encrypting, by means of a first encryption key and data unique to the mobile communication device, a transaction request to be transmitted to the transaction terminal and
transmitting a transaction request directly to the transaction terminal with the use of the mobile communication device, using a method of communication for which the transaction terminal is enabled;
transmitting the transaction request from the transaction terminal to the transaction processing server;
at the transaction processing server:

receiving the transaction request;
identifying the mobile communication device using the data unique to the mobile communication device;
retrieving the first encryption key, previously stored at the transaction processing server in respect of the mobile communication device;
decrypting the encrypted transaction request using the first encryption key;
processing the transaction request and generating a process outcome message pertaining to the result of processing of the transaction request;
generating a second encryption key, storing the second encryption key in the transaction processing server;
transmitting the second encryption key to the transaction terminal;

encrypting the process outcome message using the second encryption key; and
transmitting the encrypted process outcome message to the mobile communication device;
at the mobile communication device, extracting and storing the second encryption key and transmitting the encrypted process outcome message to the transaction terminal; and
at the transaction terminal, decrypting the encrypted process outcome message and applying the decrypted process outcome message to actuate the transaction terminal.

### BRIEF DESCRIPTION OF THE DRAWINGS

The invention will be further described with reference to the accompanying drawings in which:

FIG. 1 is a block diagram illustrating a current credit card transaction cycle;

FIG. 2 is a block diagram illustrating an internet transaction cycle;

FIG. 3 is a block diagram illustrating a credit card transaction cycle using the system of this invention;

FIG. 4 is a block diagram illustrating an internet-based credit card transaction cycle using the system of this invention;

FIG. 5 is a block diagram illustrating an internet-based banking transaction cycle using the system of this invention;

FIG. 6 is a block diagram illustrating a cheque transaction cycle using the system of this invention;

FIG. 7 is a block diagram illustrating transaction authorisation and authentication in a cheque transaction cycle using the system of this invention;

FIG. 8 is a flow chart illustrating one implementation of the invention;

FIG. 9 is a block diagram illustrating a cheque fraud protection system according to the invention;

FIG. 10 is a block diagram illustrating apparatus for implementing the method of the invention in respect of transactions involving the use of a communications enabled transaction terminal as the transaction processing client; and

FIG. 11 is a block diagram illustrating (partly in flow-chart form), one implementation of the aspect of the invention illustrated in FIG. 10.

### DESCRIPTION OF EMBODIMENTS OF THE INVENTION

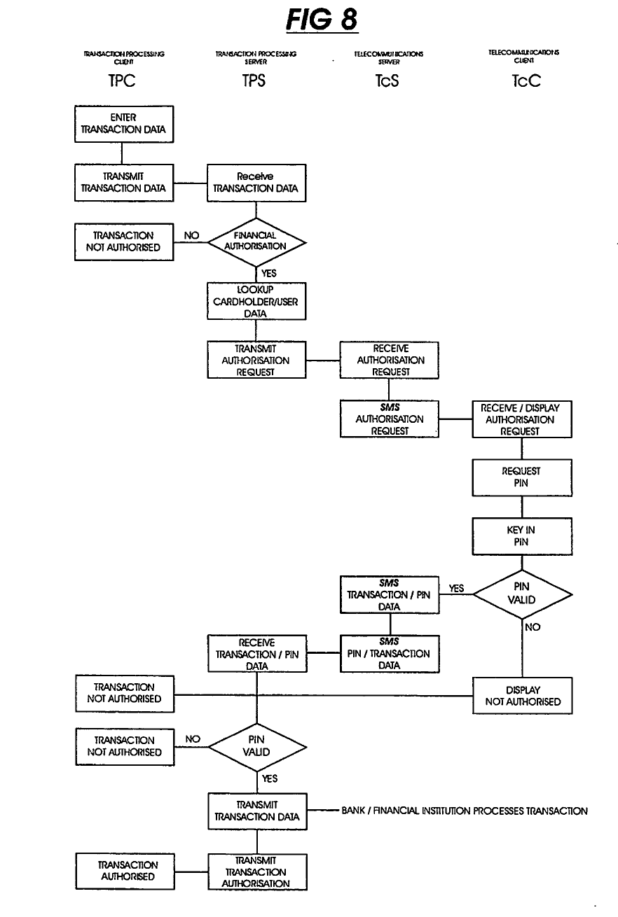

The financial transaction verification system of the invention is possibly best understood with reference to the example illustrated in the flow chart of FIG. 8.

The flow chart illustrates the example of a relatively simple financial transaction involving a point of sale (POS) payment terminal at which credit cards or cheques are used to pay for the purchase of goods. Using the example of a credit card, the credit card belongs to the person who makes a purchase and who will be referred to as the transaction initiator in this specification. The transaction initiator will have a credit card account linked to the credit card with a bank or other financial institution, which is referred to in this specification as a financial services provider.

The financial services provider operates and serves a network of point of sale terminals and other electronic transaction terminals, such as automated teller machines (ATM's) and the computers of its banking clients in circumstance where those computers serve as internet banking terminals.

This network of terminals is normally operated from a central server or servers which, in this specification, are referred to as the transaction processing server.

In a typical credit card transaction, the transaction details are entered at the POS terminal (the transaction processing client) where the credit card is swiped to obtain details pertaining to the transaction initiator, typically the credit card account number held with the financial services provider.

The transaction processing client then dials up the transaction processing server automatically, normally making use of a fixed line telecommunication network or PSTN.

In the normal course of events, using current authorisation systems, the transaction is authorised or declined in a process of communication between the transaction processing server and the financial services provider. The result of this authorisation process is then communicated back to the transaction processing client by way of the fixed line network.

It will be appreciated that the network need not be a fixed line network, particularly since mobile communication networks are being used with increasing frequency in situations such as this.

A number of credit card fraud schemes in current use are unlikely to be detected in a simple authorisation process such as this, particularly where a credit card is duplicated or cloned.

For this reason the system of the invention proposes the use, essentially, of a two-part authorisation process—one that includes a first, transaction initiation component and a final transaction authorisation component, the latter directed at final transaction authorisation and account holder (transaction initiator) authentication. This authentication step is carried out by the transaction initiator, who is best placed to control and direct such an authentication step, with assistance from the system and the financial services provider, which provides credibility to the transaction initiator and which also serves as the transaction record keeper. the latter function is important, since it serves to authenticate not only the transaction and the transaction initiator but also the fact that the transaction initiator did in fact authorise the transaction, thereby serving to reduce the possibility of chargeback fraud, which will be described in more detail below.

Using the simple credit card transaction described above, the example of the invention illustrated in FIG. 8 directs the transaction initiation component on a conventional to communications stream, using the POS terminal (the transaction processing client) and the transaction processing server and financial services provider in their normal functions. At this point, however, the process loops into a final transaction authorisation component that requires final authorisation by the transaction initiator—the card holder who has authority over the account—using a separate communications stream constituted by a mobile communications network.

In the example illustrated, the communications network is a GSM network on which data transfer is undertaken by way of SMS communications. It will be appreciated that GPRS (General Packet Radio Service) communication protocols would work equally well, if not better.

Referring to the flow chart, the card holder as transaction initiator initiates a transaction at the POS terminal that serves as a transaction processing client. Transaction data is entered into the transaction processing client, which data is normally constituted by the transaction value and details of the transaction initiators credit card account, which details are obtained in conventional fashion by swiping the credit card through a magnetic stripe reader forming part of the transaction processing client.

The transaction processing client then, as in the conventional process, dials out to the transaction processing server forming part of the financial services provider network and transmits the transaction data together with the transaction initiator account data to the transaction processing server as a transaction authorisation request.

The financial records of the financial services provider are available to the transaction processing server and on receipt by the transaction processing server, these records are interrogated by the transaction processing server to determine whether or not the transaction is financially permissible—essentially to determine whether or not the transaction initiator's credit card account has sufficient credit to permit the transaction. If not, the transaction processing server simply transmits a signal to the transaction processing client to the effect that the transaction is not authorised, as occurs normally in present day transaction processing systems.

If the transaction is financially permissible, the transaction processing server looks up the appropriate communications data of the card holder or transaction initiator in the databases of the financial services provider, in this case the mobile phone number of the transaction initiator. The transaction processing server then transmits a transaction authorisation request to a telecommunications server which, in this, example, will be constituted by an SMS gateway. On receipt, the telecommunications server converts the transaction authorisation request to an SMS, which it sends to the telecommunications client constituted by the card holder's mobile phone.

It will be appreciated that the SMS gateway must, of necessity, be one that enjoys priority routing on the mobile communications network so as not to introduce inordinate delays in the transaction authorisation process.

The card holder now receives an SMS on his or her mobile phone requesting authorisation of the transaction. If the card holder is not the transaction initiator, then the card holder can cancel the transaction immediately, and, if necessary, alert the financial services provider and possibly the police that fraud is being perpetrated.

Upon accepting the option of not authorising (or canceling) the transaction, normally by pressing the appropriate key on the mobile phone, the card holder sends an SMS to the telecommunications server which converts the SMS and sends a cancellation signal to the transaction processing client via the transaction processing server. The POS terminal, as transaction processing client, will then display a message to the effect that the transaction cannot be authorised.

In the normal course of events the card holder will be the transaction initiator.

The mobile phone, as telecommunications client, is programmed to display the SMS containing the transaction authorisation request and to await the entry of an authorisation code. This code will normally take the form of a personal identification number (PIN) previously supplied to the card holder by the financial services provider or selected by the card holder, as the case may be.

Should the card holder elect to accept the option of authorising the transaction, then by pressing the appropriate key or keys, the mobile phone sends an SMS to the telecommunications server.

The SMS from the mobile phone (serving as telecommunications client) may contain PIN and transaction data that is sent via the telecommunications server, to the transaction processing server.

On receipt by the transaction processing server, the transaction and PIN data is verified. In particular, the PIN data is verified against card holder account data held by the financial services provider. If, for some reason, the PIN data is found to be invalid, a cancellation signal is sent to the transaction processing client which displays a message to the effect that the transaction cannot be authorised.

In the normal course and since the PIN data has already gone through a verification step in the telecommunications client, the PIN data will be valid, in which case the transaction data will be transmitted to the financial services provider for processing, normally by debiting the account of the card holder.

The transaction processing server also transmits a transaction authorisation signal to the point of sale terminal as transaction processing client, which displays a message to the effect that the transaction has been authorised and produces the normal credit card slips for signature by the card holder and transaction initiator.

Whilst the system has been described above with reference to a credit card transaction, the system will work equally well in the verification of the authorisation of other financial transactions.

For instance, if the transaction processing client is a computer serving as an internet terminal, the procedure will be almost identical, once again requiring the card holder or account holder, as transaction initiator, to enter a PIN number on his or her mobile phone to verify the authorisation of the transaction.

Once again, the transaction initiation component and transaction authorisation component of the process are carried out on separate communication streams, with the final authorisation being provided by the mobile phone of the transaction initiator.

With the appropriate point of sale terminal, either in the form of a keypad, a cheque reader or both, the system of the invention can also be adapted to the verification of cheque-based transactions.

The transaction verification process follows the course outlined above, with the personal authorisation of the transaction initiator being required byway of a PIN code entered on a relatively personal device—the mobile phone of the transaction initiator—to provide final verification of the transaction.

Various forms of data encryption may be used to encrypt the messages and signals transmitted as part of this transaction authorisation and verification process, particularly bank account and PIN code data.

The financial transaction process related above is but one example of the transaction processing capacity of the system.

The current system 10 employed for the authorisation of credit card transactions is illustrated in FIG. 1. In this system a merchant presents a client's credit card 12 to a Point-Of-Sale (POS) device 14. The POS device 14 sends a request to the transaction processing server of the bank 16 that owns the POS device and that therefore “acquires” the transaction. This is normally done by means of a Public Subscriber Telephone Network (PSTN) line or a radio pad-based service, the South African example of which is known as SWIFTNET. The acquiring bank contacts the bank that issued the card (the issuer bank 18), through an authorisation network 20 that normally relies on the PSTN.

Depending on the availability of funds, the request is either approved or denied.

If approved, funds in the client's account are reserved or transferred to the merchant's account by the issuer bank 18, which notifies the acquiring bank 16 accordingly. The acquiring bank then notifies the merchant by means of the POS device 14 that the transaction has been approved.

At no point in this process is there any guarantee that the person using the credit card is indeed the rightful owner. This process only guarantees the availability of funds. It is a process that provides no more than authorisation of the transaction after ensuring that funds are available to complete the transaction. Unfortunately, however, the process does not provide any form of authentication or any other indication that the individual making the transaction is indeed the rightful owner of the card.

The lack of authentication is a problem and gives rise to a number of fraud situations, particularly in internet-based credit card transactions.

In so-called charge-back fraud, the cardholder typically denies knowledge of the transaction having taken place, typical examples including the cardholder claiming not to have received the goods or that the goods do not match what was advertised. A type of fraud known as “friendly fraud” falls into this category. This occurs when a cardholder wants to avoid paying for a potentially embarrassing type of purchase (adult content literature for instance). These types of fraud occur because merchants seldom have the time (or the ability, in the case of an internet merchant) to authenticate the identity of a cardholder. As a result, internet merchants in particular remain vulnerable to cardholder fraud and charge-back fines.

In on-line transactions, it is only the financial institution that issued a particular credit card that can vouch for the identity and authority of a user of that credit card.

The parallel authentication process of the invention protects the merchant from chargeback fraud because authentication takes place before the transaction is authorised. This ensures that the cardholder is aware of the transaction taking place and has the opportunity to cancel the transaction if it was done fraudulently. The cardholder's participation in this process is recorded, notably by one or both banks 16, 18.

Credit card transactions are typically categorised into two categories—card present and card not present transactions (internet, telephone transactions). Skimming fraud occurs when the data stored on an authentic credit card is copied and transferred onto a fake card. In an attempt to minimise the risk of this type of fraud, transaction processing personnel are required to enter certain card information, normally a number printed or embossed on the card 12. The parallel authentication process of the invention protects the cardholder since the card alone cannot complete a transaction. The fraudulent third party would have to acquire the credit card, cell phone with SIM and the cardholder's authentication PIN before any transaction will be allowed.

Merchant fraud occurs when merchants authorise and capture fraudulent transactions against the credit card numbers without the cardholder's authorisation. The parallel authentication process of the invention can alleviate this instance of merchant fraud since the credit card number alone cannot get a transaction authorised. Any attempt by the merchant to authorise transactions that are not permitted by the cardholder will be shown on the cardholder's cell phone where they can be cancelled. The cell phone as telecommunications client can be programmed for the transaction authorisation request SMS to include a merchant number, the merchant name or both for subsequent use as evidence of attempted fraud.

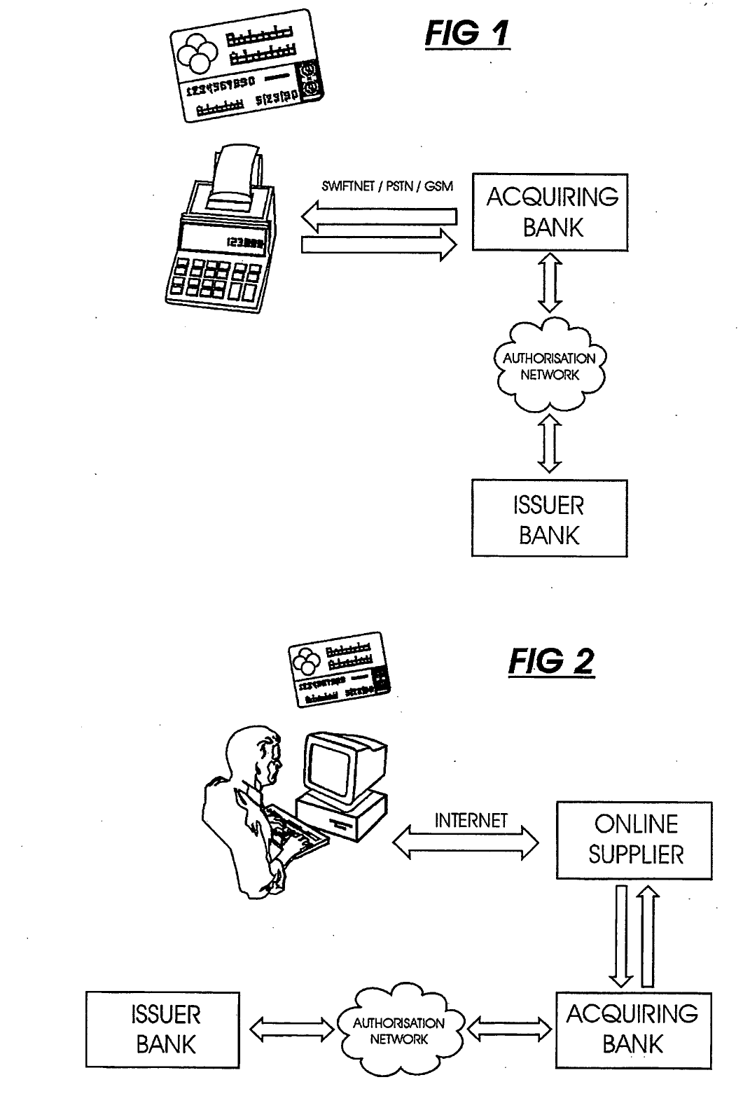

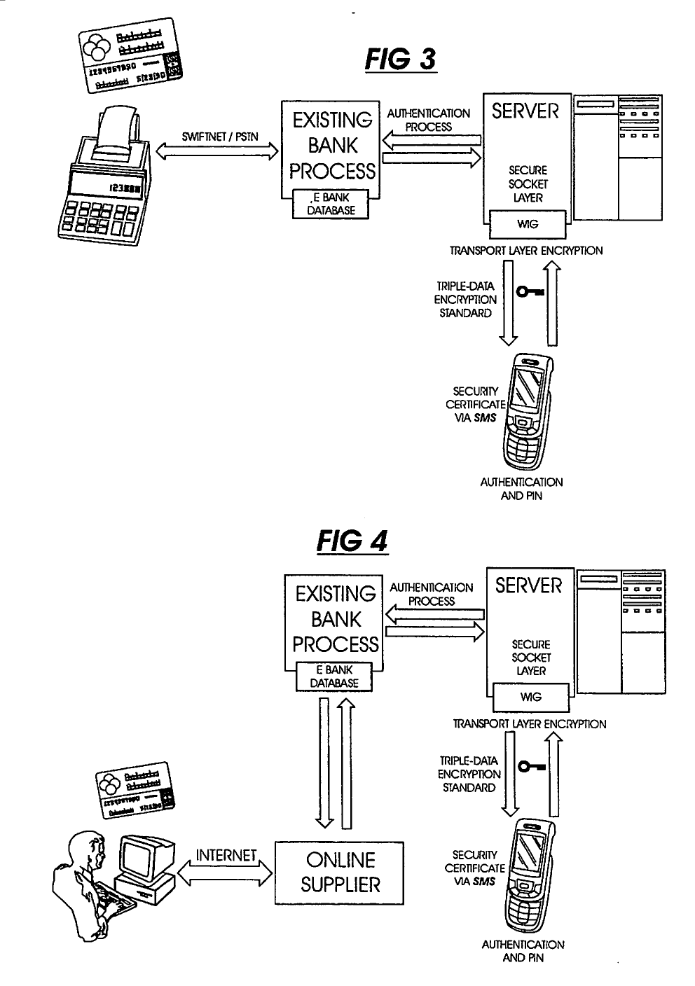

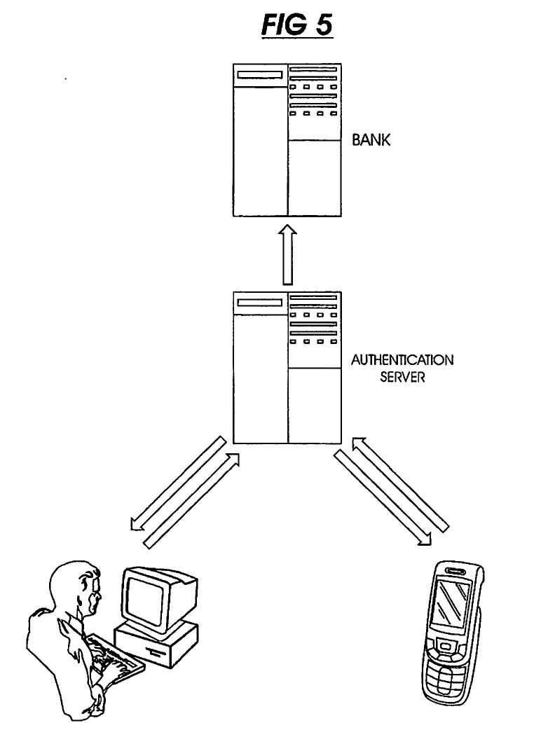

Most internet shopping systems (as illustrated in FIG. 2) involve entering details of the transaction initiator's credit card 12 on an on-line merchant's web page 22—normally the card number, the card expiry date and a CVS number or part thereof (a number normally printed on the reverse of the card). Using this information, the transaction is normally authorised.

Again, there is no authentication. Anyone can use the credit card number for purchases on the net.

The banks have employed methods to combat the potential for fraud in transactions of this type, normally involving the transmission of one-time-generated passwords to clients. This method relies on the password reaching the intended client, thus exposing the password to man-in-the-middle attacks (which normally involve a person masquerading as the proper destination, intercepting the communication and then misusing the password so transmitted). To combat these attacks, a number of banks now employ a pop-up keypad on their websites, the intention being to prevent the keystrokes from being captured via a computer worm. This system can be circumvented.

The parallel authentication process of the invention transaction cycle includes the existing bank process, but has an additional process for authentication before the transaction is approved.

Online banking (internet banking) is convenient, but without the proper security, this form of banking can be hazardous and a number of security systems have been introduced by banks, including an on-screen keypad that is displayed on the clients internet terminal with scrambled keys that are used to enter the client's PIN. Another method employed is sending a generated PIN via SMS to the client in order to facilitate the online transaction.

These methods tend to introduce new weaknesses and a sense of false security. Firstly, the keypad security can be hacked by obtaining the relative mouse click positions. The keypad is scrambled based on a set algorithm that can be deciphered. Hiding a computer worm or Trojan horse behind the client's firewall exposes the client to fraud and an SMS can be diverted to another phone or the phone could have been stolen.

The parallel authentication process of the invention method can be successfully employed for internet banking. Even though it also uses SMS as the communication bearer, the client's identity can be guaranteed. If the SMS is diverted to another phone, authentication will fail because the SIM number and IMEI number of the phone will differ.

Notwithstanding the increase in electronic funds transfer mechanisms and the increased use of such mechanisms, cheques remain one of the dominant methods of payment in commerce, particularly where larger amounts are concerned. Unfortunately, cheques are a relatively easy target for fraud. This is due largely to the fact that cheque fraud detection remains a predominately manual operation.

Cheque fraud is so common these days, that many merchants do not accept cheques as payment anymore. The risk involved with accepting a cheque is just too great. Common problems are Return to Drawer (RD) cheques where funds are not available for the amount stipulated in the cheques, cloned cheques where the beneficiary of the cheque is changed, forged signatures on cheques and many more. Currently, the banks attempt to do some form of authentication by visual signature screening or calling the client if a cheque above a certain value is about to be cashed. Only once the client has given his/her permission is the cheque cleared. The weakness in the system is that voice calls can be diverted from the client's official contact number, to any other telephone number. There is no way the bank can be sure that the person on the other end of the line is really the client.

The parallel authentication process of the invention system properly implemented can limit cheque fraud to the absolute minimum. There is no human intervention since the whole process is done automatically.

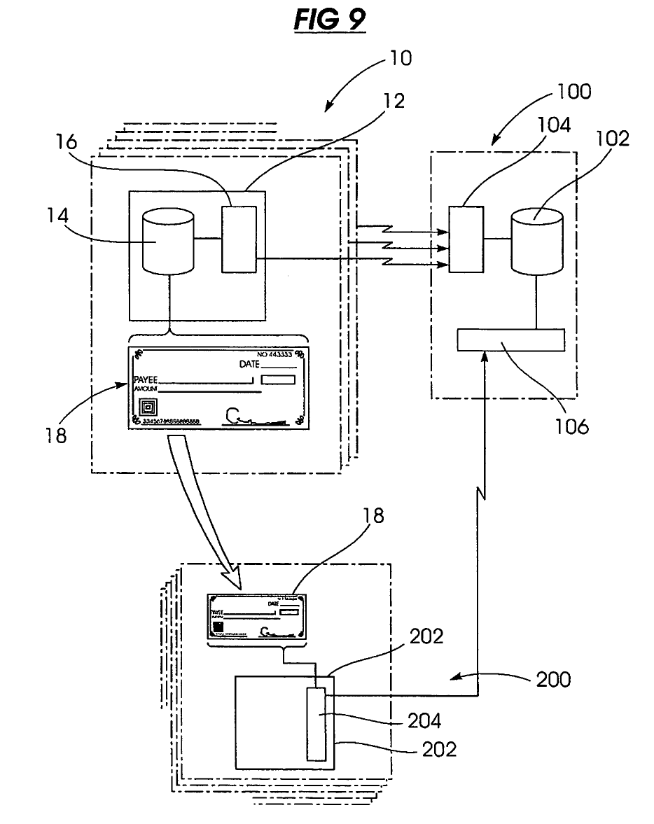

The cheque fraud protection system illustrated in FIG. 9 comprises three discrete subsystems:
an issuer subsystem;
a central processing subsystem; and
a presentation point subsystem.

It is anticipated that a large number of negotiable instrument issuers will participate in a system such as this. The same applies to the presentation point subsystem which will see a large number of presentation points participating in the system.

Each issuer subsystem 110 comprises a data entry terminal 112 with a local database 114 and an issuer front end 116. The issuer front end 116 is intended to provide an issuing user with data entry forms. It also provides an internet link.

The central subsystem 1100 comprises a central database 1102, an issuer interface 1104 and a presentation point interface 1106.

The presentation points 1200 each comprise a data entry terminal with a presentation point front end 1104 that provides the user at the presentation point with data entry and data query forms.

In operation, payments are processed through the system as follows.

Cheque issuers wishing to participate in the system must first register with the system. In the process of registering such a cheque issuer, a negotiable instrument issuer code unique to the cheque issuer is registered on the system. These unique negotiable instrument issuer codes will be stored in the central subsystem 1100, either as part of the central database 1102 or in a separate database. The negotiable instrument issuer code may be anything from a password to a biometric code and various levels of access may be provided to facilitate operation of the system. In this way, operator personnel will be able to enter data pertaining to one or more cheques 118 into the local database 114 forming part of the data entry terminal 112 using data entry forms provided by the issuer front end 116. However, the person with final cheque signing authority at the issuer will then be required to enter the negotiable instrument issuer code by means of which the data pertaining to the cheque or cheques 118 will be confirmed and validated.

Most cheque fraud involves manipulation of payee or amount data on the face of the cheque. The most important data pertaining to a cheque to be entered on the system, therefore, includes data pertaining to the payee, the amount (preferably in words and in numbers) and data pertaining to identification of the cheque, typically the cheque number. It would be convenient, in addition, to enter data pertaining to the date of issue of the cheque.

Once all of this data pertaining to the cheque 118 has been entered into the data entry terminal 112, the cheque issuer then validates the data by entering the appropriate negotiable instrument issuer code. In this way, the cheque issuer, in effect, places an “electronic signature” on the cheque. This “electronically signed” cheque is then sent to the payee for processing in the normal course. At the same time, the issuer front end 116 transmits the validated data pertaining to the cheque 118 by way of an internet link to the issuer interface 1104 in the central subsystem 1100 which transmits the data for processing and storage in the central database 1102.

The cheque 118, having made its way to the payee, is then presented for payment at a presentation point 1200 which may be constituted by the bank of the payee, a bank teller or some other cheque clearing facility.

In a conventional cheque processing system the cheque 118 will be validated upon presentation using largely manual techniques, including visual inspection of the cheque for possible tampering and forgery and visual comparisons of the actual signature of the cheque signatory with sample signatures of that signatory, once again to determine if any forgery has taken place.

In contrast with this, the system of the invention requires no such inspection.

At the presentation point 1200, the relevant data pertaining to the cheque 118 is simply entered into the presentation point front end 1104 forming part of the presentation point data entry terminal 1102. The presentation point front end 1104 communicates, via internal or internet link with the presentation point interface 1106 of the central subsystem 1100 which draws the validated data pertaining to the cheque 118 into the presentation point front end 1104. This allows immediate comparison between the validated data pertaining to the cheque 118 with the data appearing on the face of the cheque 118 at the time of presentation.

No other visual inspection or comparisons are required. If the data on the face of the cheque 118 corresponds identically with the validated data stored in the central database 1102, the cheque can be cleared for payment or the account of the payee can be credited.

If, on the other hand, the data on the face of the cheque 118 does not correspond identically with the corresponding data stored in the central database 1102, the cheque cannot be cleared for payment.

Other than this, no inspection of the cheque is required nor is any comparison of signatures required.

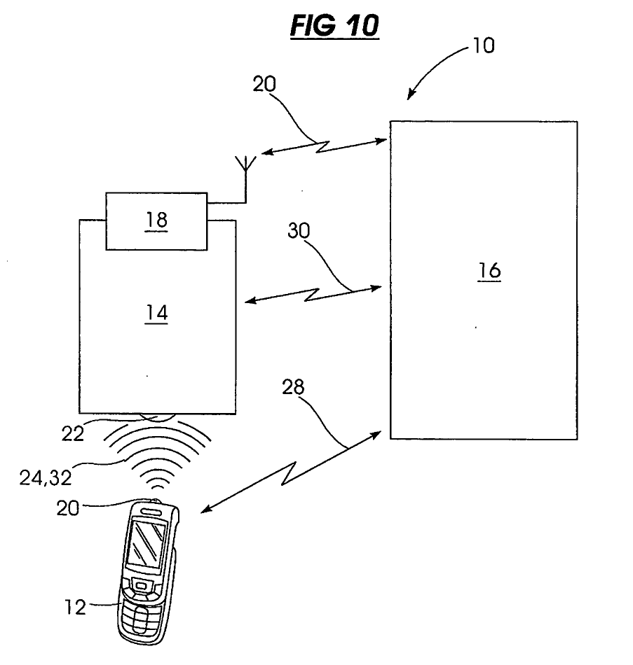

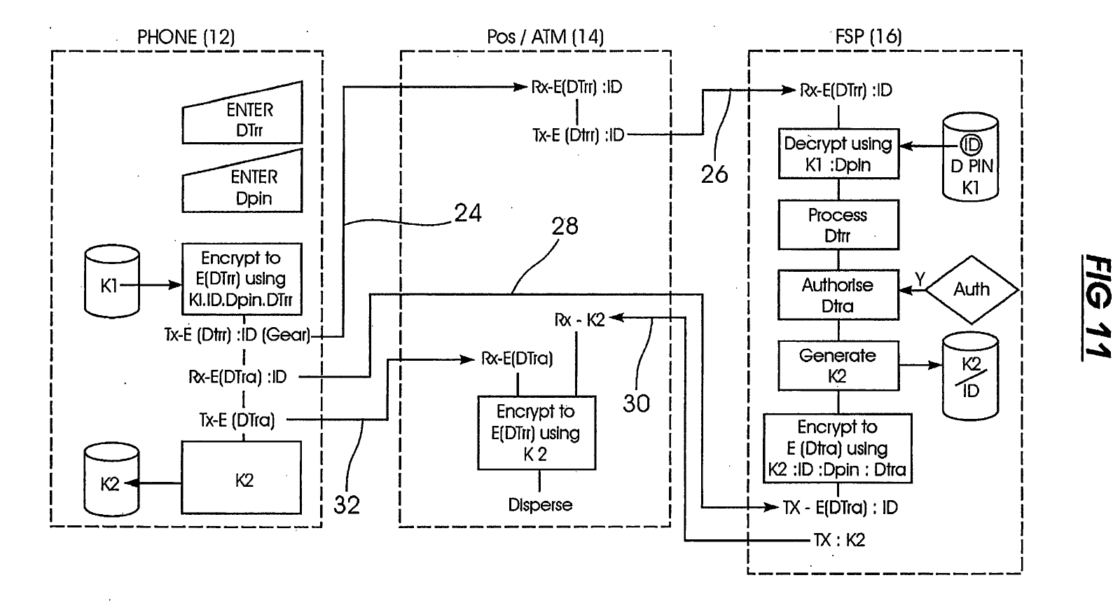

The invention extends to the verification of financial transactions involving the use of a communications enabled transaction terminal as the transaction processing client, as illustrated in FIGS. 10 and 11.

The invention will be described with reference to the use of a cellular telephone or mobile telephone as the personal communication device. In addition, the invention will be described with reference to a point of sale (POS) terminal or an automated teller machine (ATM) as a transaction terminal. This is done purely by way of example and it is not intended thereby to limit the invention.

The system 310 illustrated in FIG. 10 is a transaction processing system that utilises a cellular telephone 312 to communicate with a POS terminal or ATM 314. Transactions requested within the transaction processing system 310 will require authorisation by a transaction processing authority constituted, in this case, by a financial services provider 316. For ease of reference, the transaction terminal will be taken to be an ATM.

Communications between the ATM 314 and the financial services provider316 are byway of a GSM communicator 318. Alternatively or in addition, communication between the ATM 314 and the financial services provider 316 may take place on conventional communication networks incorporating the ATM 314, such as a conventional telephone network.

To enhance the security of the transaction processing system 310, communications between the cellular telephone3l2 and the ATM 314 are by way of very short range communications links. Most cellular telephones are equipped with infrared transceivers 320. Infrared is a relatively secure form of short range communication. The ATM 314 can be fitted with an infrared transceiver 322 relatively simply.

A person wishing to initiate a transaction simply enters the transaction details on the cellular telephone 312 and, using the appropriate features on the telephone, transmits a first infrared signal 324 to the ATM 314.

This process is best illustrated with reference to FIG. 11.

As can be seen from FIG. 11, a person wishing to initiate a transaction starts off by entering transaction data (DTrr) into the telephone 312. Upon registration within the transaction processing system 310, the person concerned will have been issued with a personal identification number (PIN) and at this point the person will be prompted to enter the PIN as data (DPIN) into the cellular telephone 312. Within the cellular telephone 312, the data so entered (DTrr and DPIN) will be encrypted using a first encryption key (K1) as well as the identification number (ID) of the telephone 312 (which may be a manufacturer's serial number or some other telephone identification number allocated upon registration within the system 310) and the data previously entered (DPIN and DTrr). Not all of this information needs to be used in preparing the encrypted transaction request—E(DTrr).

The encrypted transaction request (E(DTrr)) is then transmitted to the ATM 314 by way of a first infrared transmission 324. The telephone ID can be sent as clear text.

On receipt within the ATM 314, the encrypted transaction request (E(DTrr) ) together with the telephone ID is transmitted by way of a transmission 326 to the financial services provider 316.

The message received at the financial services provider 316 (E(DTrr):ID) must now be decrypted.

The financial services provider 316 has data pertaining to the user and the telephone 312 stored in its databases, which data is linked to the telephone 312 by way of the telephone ID, the most important being data pertaining to the user's PIN (DPIN) and the first encryption key (K1). The manner in which encryption keys are generated and stored will be described in more detail below.

On receipt of the encrypted transaction request (E(DTrr):ID), the financial services provider 316 retrieves this stored data and, using this data (particularly K1:DPIN) it is able to decrypt the encrypted transaction request (E(DTrr))and to process the transaction request.

The outcome of this process will either be positive (for instance to dispense funds or to display account information) or there will be some other outcome (for instance, not to dispense funds or not to display account information, transfer funds or some other message).

The process outcome message must be communicated both to the person requesting the transaction and to the ATM 314, since the ATM 314 in particular will be required to perform certain functions in response thereto. In view of the potential sensitivity of this information, this information is encrypted.

The process of encryption is undertaken by the financial services provider which generates a second encryption key (K2). The second encryption key (K2) is stored in the databases of the financial services provider 316 and linked to the telephone ID to facilitate future retrieval of the key. The second encryption key (K2) or a derivative thereof will be used as the decryption key (K1) in the next transaction processing cycle.

Assuming that the transaction is authorised, the financial services provider generates a transaction authorisation message (DTra). The financial services provider 316 encrypts the transaction authorisation message (DTra) using the second encryption key (K2) and other data typically the telephone ID, the PIN number (DPIN) and the data pertaining to the transaction authorisation message (DTra).

The encrypted transaction authorisation message (E(DTra)) is then transmitted to the telephone 312 by way of the GSM network, the most convenient form of transmission being as a Short Message Service (SMS) message 328. At the same time, the financial services provider 316 transmits the second encryption key ((K2)) to the ATM 314, by way of a communication 330 between the financial services provider 316 and the ATM 314.

On receipt within the telephone 312, the encrypted transaction authorisation message (E(DTra)) is transmitted to the ATM 314 by way of a second infrared message 332.

Within the ATM 314 the encrypted transaction authorisation message (E(DTra)) is decrypted using the second encryption key (K2) received from the financial services provider 316. The second encryption key (K2) is transmitted to the telephone 312 as part of the infrared communication 332 and the decrypted transaction authorisation message (DTra) is used to direct the operation of the ATM 314. In this example, the ATM 314 is instructed to dispense funds to the person who originally requested the transaction.

Within the telephone 312, the second encryption key (K2) is now stored in a database. internet banking is illustrated in FIG. 4. The client logs onto the bank's internet banking web page. The authentication server sends an authentication request to the client's cell phone. The client confirms he/she is aware of the log on request and enters his/her PIN. If the PIN, SIM number and IMEI number coincides with the records, the client is given access to his/ her accounts.

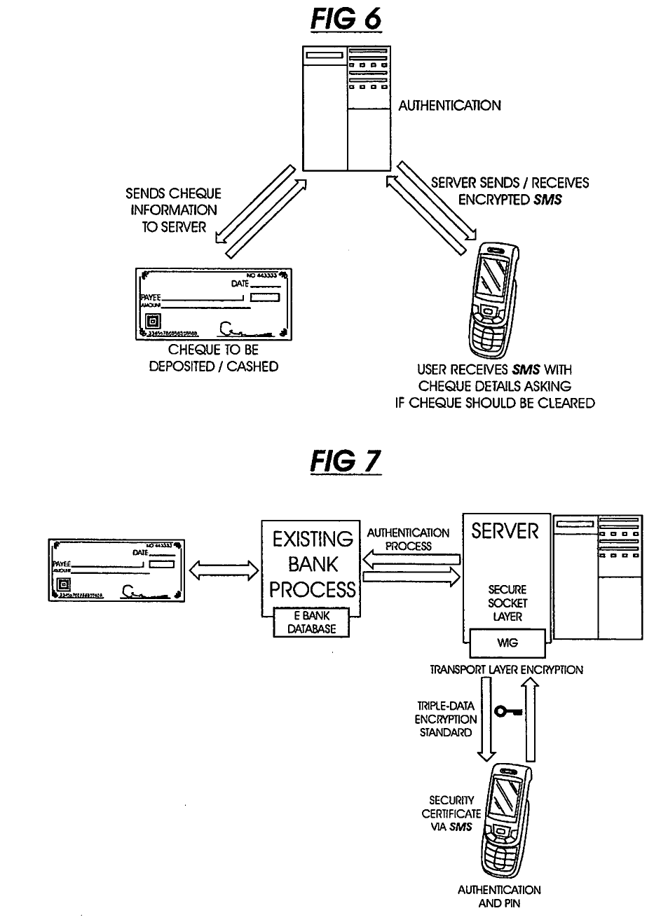

A further example of the financial transaction verification system of the invention as applied to cheque transactions is illustrated in FIGS. 6 and 7.

When a client's cheque is presented for payment and before the cheque is cleared, the bank sends the cheque information to the client's cell phone. The client confirms he/she is aware of the transaction and enters his/her password. An encrypted SMS is then sent from the client's cell phone to the authentication server via the WIG. The authentication server authenticates that the correct client responded by cross checking the IMEI, SIM card number, MSISDN and the password. Any variances in these parameters will result in authentication failing and the cheque being rejected.

This system can also be used in a process similar to the credit card transaction cycle (see FIG. 7). The vendor can thus be certain that there is enough funds in the clients account and that the client is the rightful owner of the cheque account.

1. A financial transaction verification system comprising:
a transaction processing client;
a transaction processing server under the control of a financial services provider;
a programmable telecommunications client under the control of a transaction initiator;
the transaction processing client, the transaction processing server and the telecommunications client all being connected to or adapted for connection to a telecommunications network;
the transaction processing client being adapted, when in use a transaction is initiated and processed through the transaction processing client, to record:
data pertaining to a transaction initiated, in use, by the transaction initiator; and
data pertaining to a financial account of the transaction initiator with the financial services provider;
the transaction processing client being adapted to transmit the recorded data to the transaction processing server by way of the telecommunications network;
the transaction processing server being adapted to make use of data pertaining to the transaction initiator and the telecommunications client previously stored with the financial services provider to formulate a transaction authorisation request to the telecommunications client;
the transaction processing server being adapted to transmit the transaction authorisation request to the telecommunications client by way of the telecommunications network;
the telecommunications client being programmed to require the entry of an authorisation code into the telecommunications client as a precondition for the further processing of the transaction authorisation request; and
the telecommunications client being programmed, further, to transmit a process outcome message to either or both the transaction processing server and the transaction processing client, which process outcome message:
if the incorrect authorisation code is entered, is constituted by a transaction cancellation signal; and
if the correct authorisation code is entered, is constituted by a transaction authorisation signal.

2. A financial transaction verification system according to claim 1 in which the telecommunications client is a mobile communication device that is personal to the transaction initiator, in which system:
the transaction initiator data previously stored with the financial services provider includes unique mobile communication device data, which is data that is unique to and stored in the mobile communication device;
the transaction processing server is adapted to transmit the previously stored unique mobile communication device data to the mobile communication device together with the authorisation request;
the mobile communication device is programmed, on receipt of the transmitted data, to compare the transmitted data to the equivalent unique mobile communication device data stored in the mobile communication device;
the telecommunications client is programmed, further, to transmit a process outcome message to either or both the transaction processing server and the transaction processing client, which process outcome message may, alternatively, be constituted by a transaction cancellation signal or a transaction authorisation signal;
the mobile communication device being programmed, further:
if the comparison between the transmitted data and the equivalent data stored in the mobile communication device fails, to transmit a process outcome message constituted by a transaction cancellation signal; and
if the comparison is successful, to require the entry, into the mobile communication device, of the authorisation code previously provided as a precondition for the further processing of the transaction authorisation request;
and if the incorrect authorisation code is entered, to transmit a process outcome message constituted by a transaction cancellation signal; and
if the correct authorisation code is entered to transmit a process outcome message constituted by a transaction authorisation signal.

3. A financial transaction verification system according to claim 1 that is adapted:
to cancel the transaction in the event of the receipt, by the telecommunications client, of a transaction cancellation signal ; and
to allow the transaction to proceed to finality in the event of the receipt, by the telecommunications client, of a transaction authorisation signal.

4. A transaction processing client for use with a system according to claim 1.

5. A transaction processing server for use with a system according to claim 1.

6. A telecommunications server for use with a system according to claim 1.

7. A telecommunications client for use with a system according to claim 1.

8. A method of verifying a financial transaction comprising the steps of:
initiating a transaction at a transaction processing client;
recording, by means of the transaction processing client, data pertaining to the transaction together with data pertaining to a financial account of the transaction initiator with a financial services provider;
transmitting the data so recorded from the transaction processing client to a transaction processing server under control of the financial services provider, by way of a telecommunications network,
supplying, to the transaction processing server, data previously stored with the financial services provider and pertaining to a telecommunications client which is under the control of the transaction initiator;
transmitting an authorisation request pertaining to the initiated transaction to the telecommunications client;
requiring, on receipt of such a transaction authorisation request, the entry into the telecommunications client, of an authorisation code as a precondition for the further processing of the transaction authorisation request;
transmitting a process outcome message to either or both the transaction processing server and the transaction processing client, which process outcome message:
if the incorrect authorisation code is entered, is constituted by a transaction cancellation signal ; and
if the correct authorisation code is entered, is constituted by a transaction authorisation signal.

9. A method of verifying a financial transaction according to claim 8 in which the telecommunications client is a mobile communication device personal to the transaction initiator and data unique to and stored in the mobile communication device is stored by the financial services provider as part of the communications data pertaining to the transaction initiator, the method including the additional steps of:
transmitting the unique mobile communication device data from the transaction processing server to the mobile communication device together with the authorisation request;
in the mobile communication device, comparing, on receipt of the transmitted data and authorisation request, the transmitted unique mobile communication device data to the equivalent mobile communication device data stored in the mobile communication device; and
if the comparison between the transmitted data and the equivalent data stored in the mobile communication device fails, transmitting a transaction cancellation signal to either or both the transaction processing server and the transaction processing client; and
if the comparison is successful, requiring the entry of the authorisation code previously provided into the mobile communication device as a precondition for the further processing of the transaction authorisation request; and
if the incorrect authorisation code is entered, transmitting a transaction cancellation signal to either or both the transaction processing server and the transaction processing client; and
if the correct code is entered, transmitting a transaction authorisation signal to either or both the transaction processing server and the transaction processing client.

10. A method of verifying a financial transaction according to claim 8 which includes the additional steps of:
canceling the transaction in the event of the receipt, by the telecommunications client, of a transaction cancellation signal; and
allowing the transaction to proceed to finality in the event of the receipt, by the telecommunications client, of a transaction authorisation signal.

11. A method of verifying a financial transaction according to claim 8 in which the transaction involves the use of a documentary negotiable instrument, the method comprising the steps of:
initiating the transaction by a participating negotiable instrument issuer issuing the negotiable instrument manually;
recording, by means of the transaction processing client, data pertaining to the transaction including predetermined data pertaining to the negotiable instrument;
transmitting the data so recorded from the transaction processing client to the transaction processing server by way of the telecommunications network,
transmitting, to either or both the financial services provider and the transaction processing server, a negotiable instrument issuer code unique to the negotiable instrument issuer, thereby to confirm, to the transaction processing server, the transmitted data pertaining to the transaction including the predetermined data pertaining to the negotiable instrument;
recording, at the transaction processing server, the data so confirmed; and
comparing, when in use the negotiable instrument is presented for payment, the data on the face of the documentary negotiable instrument with the data recorded in the transaction processing server in respect of that negotiable instrument.

12. A method of operating a transaction processing server for use in a financial transaction verification method according to claim 11, the method comprising the steps of:
receiving the entry of data pertaining to negotiable instruments from participating negotiable instrument issuers;
receiving, from each participating negotiable instrument issuer and in respect of the data pertaining to each such negotiable instrument, a unique negotiable instrument issuer code;
confirming the validity of each negotiable instrument issuer code so entered by comparing the negotiable instrument issuer code so entered with a negotiable instrument issuer code stored in the transaction processing server; and
permitting a participating presentation point to gain access to the data stored in respect of a particular negotiable instrument when that negotiable instrument is presented for payment, thereby to allow comparison between the stored data and the data appearing on the face of the negotiable instrument.

13. A method of verifying a financial transaction according to claim 8 in which the transaction involves the use of a communications enabled transaction terminal as the transaction processing client, the method including the steps of:
with the use of the mobile communication device, formulating and encrypting, by means of a first encryption key and data unique to the mobile communication device, a transaction request to be transmitted to the transaction terminal and
transmitting a transaction request directly to the transaction terminal with the use of the mobile communication device, using a method of communication for which the transaction terminal is enabled;
transmitting the transaction request from the transaction terminal to the transaction processing server;
at the transaction processing server:
receiving the transaction request;
identifying the mobile communication device using the data unique to the mobile communication device;
retrieving the first encryption key, previously stored at the transaction processing server in respect of the mobile communication device;
decrypting the encrypted transaction request using the first encryption key;
processing the transaction request and generating a process outcome message pertaining to the result of processing of the transaction request;
generating a second encryption key, storing the second encryption key in the transaction processing server;
transmitting the second encryption key to the transaction terminal;
encrypting the process outcome message using the second encryption key; and
transmitting the encrypted process outcome message to the mobile communication device;
at the mobile communication device, extracting and storing the second encryption key and transmitting the encrypted process outcome message to the transaction terminal; and
at the transaction terminal, decrypting the encrypted process outcome message and applying the decrypted process outcome message to actuate the transaction terminal.

14. A method of verifying a financial transaction according to claim 13 in which the second encryption key that is stored at the transaction processing server and in the mobile communication device is used, in a following transaction processing cycle as the first encryption key.

15. A method of verifying a financial transaction according to claim 14 in which the second encryption key is generated, every time the transaction processing cycle is repeated, with the use of code hopping techniques.

16. A method of verifying a financial transaction according to claim 13 in which, in the process of encrypting the transaction request to be transmitted to the transaction processing server, the transaction request is encrypted with the use, in addition, of a code unique to the person requesting the transaction.
